(19) United States
(12) Patent Application Publication
(10) Pub. No.: US 2011/0131140 A1
(43) Pub. Date: Jun. 2, 2011

(54) Refurbishing and resale techniques for data storage cartridges

(75) Inventor: Peter Groel, Longmont, CO (US)

(73) Assignee: MOUNTAIN ENGINEERING II, INC., Longmont, CO (US)

(21) Appl. No.: 12/954,830

(22) Filed: Nov. 26, 2010

Related U.S. Application Data
(60) Provisional application No. 61/265,282, filed on Nov. 30, 2009.

(51) Int. Cl. G06Q 30/00

(52) U.S. Cl. 705/306; 705/1.1

(57) ABSTRACT

The method of determining the quality of tape cartridges by calculating a single quality score, and of disclosing this quality score to a buyer during the reselling of a cartridge. The quality score of the cartridge is the sum of a plurality of weighted statistical data that are indicative of the cartridge quality. The statistical data may include statistical data stored in the memory of the cartridge, edge quality data measured during the refurbishing process, and others. The quality score is stored in the cartridge memory.

### TECHNICAL FIELD

This invention relates to data storage cartridges and to improved techniques for refurbishing and reselling data storage cartridges.

### BACKGROUND

Data storage cartridges containing disk, magnetic tape, optical tape, and similar are commonly used to backup and to archive data.

Although in the following we refer mainly to cartridges containing magnetic tape, the invention applies also to cartridges containing optical tape, disks, and similar.

### Refurbishing of Data Cartridges

In many instanced data cartridges are “refurbished” before they are resold. Refurbishing typically means that the data recorded by the previous owner of the cartridge are erased. Several methods of erasing the user's data are known. Most modern tapes contain reference tracks called servo tracks, which are magnetically recorded during the manufacturing process of the tape. Without these servo tracks tape drives can neither record data on tape nor retrieve data from tape.

### Reselling of Data Cartridges

### Use of Life Information

The reselling of the cartridges may involve estimating the remaining useful life of the cartridge. In some cases the manufacturer of a data cartridge may specify the number of times a cartridge can be loaded in a tape drive device that is suitable for writing data to the cartridge and reading data from the cartridge. For cartridges containing tape, a manufacturer may also specify the number of times the tape can be moved from beginning of tape to the end of tape. There are several known methods of calculating the number of times the cartridge has been loaded into a tape drive and for obtaining the number of times the tape has been moved end to end. The remaining life of the cartridge is calculated by subtracting these numbers from the numbers specified by the manufacturer.

There are several problems with this method, some of which are listed in the following.

Most manufacturers of data cartridges do not publish expected life information. The above-described method cannot be used for those manufacturers, since significant differences in the manufacturing process between manufacturers prevent applying life information data published by one manufacturer to cartridges of other manufacturers.

Further, the rate at which a data cartridge deteriorates is not a constant. The quality of the manufacturing process has a bearing in determining the initial condition of the cartridge. Beyond that, several parameters determine the rate of deterioration. Some exemplary parameters will now be discussed.

Environmental conditions such as temperature and humidity, if they are outside of recommended limits, can greatly accelerate the wear of the cartridges.

The recording surface of the tape can wear excessively due to contaminated components in the tape path of the recording device. This excessive wear creates debris that can further contaminate the recording device, which leads to further wearing of the recording surface. Wear of the recording surfaces results in high number of read and write errors which may not be recoverable.

Tape wear can also occur in the tape guiding process within a tape drive. Tape drives guide the tape through the tape path with guiding elements. In most cases rollers are used as guiding elements. The tape is guided laterally by spinning flanges of the rollers. Inaccuracies of the tape edge and of the rollers can result in the flange striking the tape edge with each revolution. The rollers, which in some cases are turning faster than 10,000 rpm, can cause wear of the tape edge.

Loss of the tape to recording head alignment can result in highly undesirable read and write failures. Tape drives guide tape by pushing the lower or upper tape edge against a reference surface. This edge is known as the reference edge. It is crucial that the tape and the recording head are in alignment when reading data from tape or writing data to tape. Head actuators can move the reading and recording head to follow the lateral movement of tape. This method works well when the tape edges are straight or when they follow a gentle wave. However, tape that has worn edges is prone to sudden lateral movements. The actuator may not be able to move the recording head fast enough to follow these sudden tape movements, thus resulting in read and write failures.

The above-described examples show that the environmental conditions to which the cartridge is exposed, as well as the condition of the tape drives that are used for reading and writing the tapes, matter greatly with respect to the condition of the cartridge. The above-described three examples are listed for illustration only to demonstrate that cartridges do not deteriorate at a constant rate. Other parameters such as the age of a cartridge, for example, also influence the rate of deterioration of a cartridge.

Life information is not able to take any of these parameters into account. A cartridge that has been used beyond its recommended life in a well-maintained environment and in well-maintained tape drives may not have deteriorated at all and there is no need to discard such a cartridge. On the other hand, a poorly maintained cartridge that has been used only a few times may have deteriorated significantly. Continued use of such a cartridge poses a high risk for loss of the user's data.

The use of life information in the resale of cartridges is arbitrary, unsatisfactory and, in many cases, highly misleading. A better method is therefore desired.

### Use of Pre-Defined Resale Threshold

Known resale techniques include determining a predefine threshold of remaining tape life and reselling the tape when its expected remaining life exceeds this threshold. As shown above, the use of life information is unreliable. The following shows that the use of a pre-defined threshold is also undesirable.

Magnetic tape is used in many applications. The requirements for the performance of the tape vary between the applications. In instances where the original data that are archived to tape are not expected to remain available, and in cases where the recreation of the data is cumbersome or impossible, a highly reliable archive process is desired. In these cases only tape cartridges with high performance are desired. On the other hand, in cases where the archived data can be readily recreated, a lower performance cartridge may suffice.

Establishing a threshold to determine whether to sell a cartridge is also undesirable for the reseller. Purchasing a flawed cartridge and discarding this cartridge because it is below a pre-defined resale threshold is economically undesirable. If a pre-define threshold is used at all, it should be used to determine whether to purchase the cartridge from the original seller.

As shown in the above, the problem with the refurbishing and reselling methods of the prior art is twofold: First, the use of life information which attempts to predict the future remaining life of a cartridge is flawed. Second, the use of a fixed threshold as a decision point in whether to sell or not to sell a cartridge fails to take the variety of user requirements into account.

### SUMMARY OF THE CURRENT INVENTION

The current invention discloses the method of determining the quality of tape cartridges and of disclosing this quality information to a buyer during the reselling of a cartridge.

Quality information is different from life information. Quality information is intended to accurately measure the performance of a cartridge at the time of its resale without attempting to predict the future performance of the cartridge. By informing a potential buyer of the quality of the cartridge, the buyer can make an informed decision whether to buy this cartridge, at what price to buy it, and for what purpose to use it.

It may also be desirable for a reseller to sell cartridges at different prices. A low-scoring cartridge may be sold at a lower price, while a high-scoring cartridge may be sold at a higher price.

In the preferred embodiment all data are erased without erasing the servo tracks. The strength of the magnetic field erasing the data should be high in order to ensure that no data remain on tape. High magnetic fields are achieved by using permanent magnets. The shape of the magnetic field is defined by a low resistance path.

### BRIEF DESCRIPTION OF THE DRAWINGS

FIG. 1: Diagram of the erasing procedure for a representative sample of a tape containing servo tracks and data tracks.

FIG. 2: Schematic of an erase head.

FIG. 3: Tape deck including erase head, tape cleaner, and edge sensor

FIG. 4: Representative sample of a data cartridge containing a memory device.

FIG. 5: shows a front view of tape deck, including a cartridge with a section removed to show the location of the cartridge memory.

FIG. 6: Device to access cartridge memory.

FIG. 7: Exemplary graph for determining the R value of a parameter

### DETAILED DESCRIPTION

### Erasing the Data

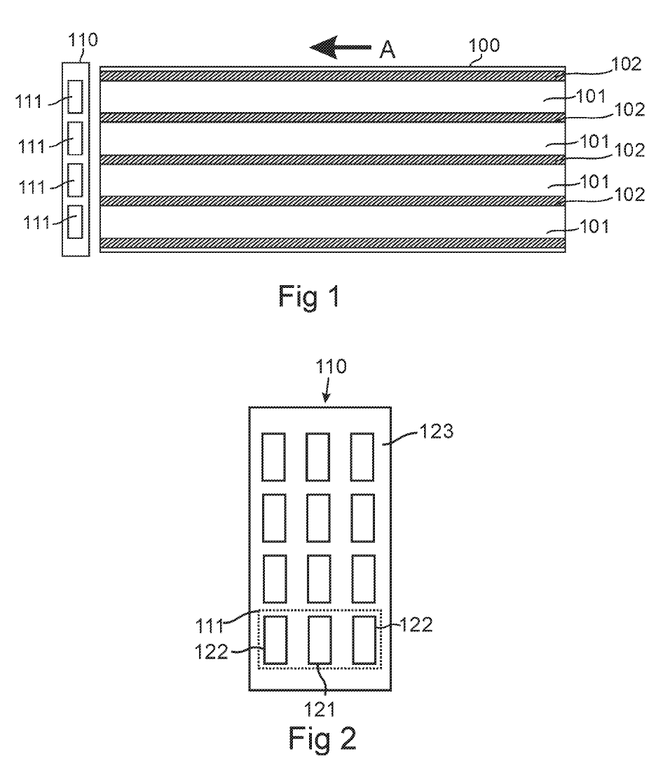

In the preferred embodiment the data on tape are erased while the servo tracks are not erased. In FIG. 1 a representative sample of a tape containing magnetically recorded servo tracks is shown. Tape 100 contains five servo tracks 102. In between the servo tracks are four areas 101 that contain data tracks. Tape 100 is moved in the direction of arrow A over erase head 110. Erase head 110 comprises several erase elements 111. These erase elements span the width of the tape that contain data tracks. The gaps between the erase elements 111 are positioned to coincide with the location of the servo tracks 102. While tape is moved over the erase head the data tracks are erased while the servo tracks remain unchanged.

The erase head surface is shown in greater detail in FIG. 2. The housing 123 is made from material that is magnetically not conductive, such as aluminum. Each of the erase elements 111 comprises three components. Permanent magnet 121 is centered between two elements 122. Elements 122 are made from material that has low resistance to magnetic fields, such as steel. The magnetic field of permanent magnet 121 is therefore contained within the area required to erase the data in the data areas 101. The strength of the magnetic field of permanent magnets is sufficient to erase all data on the tape.

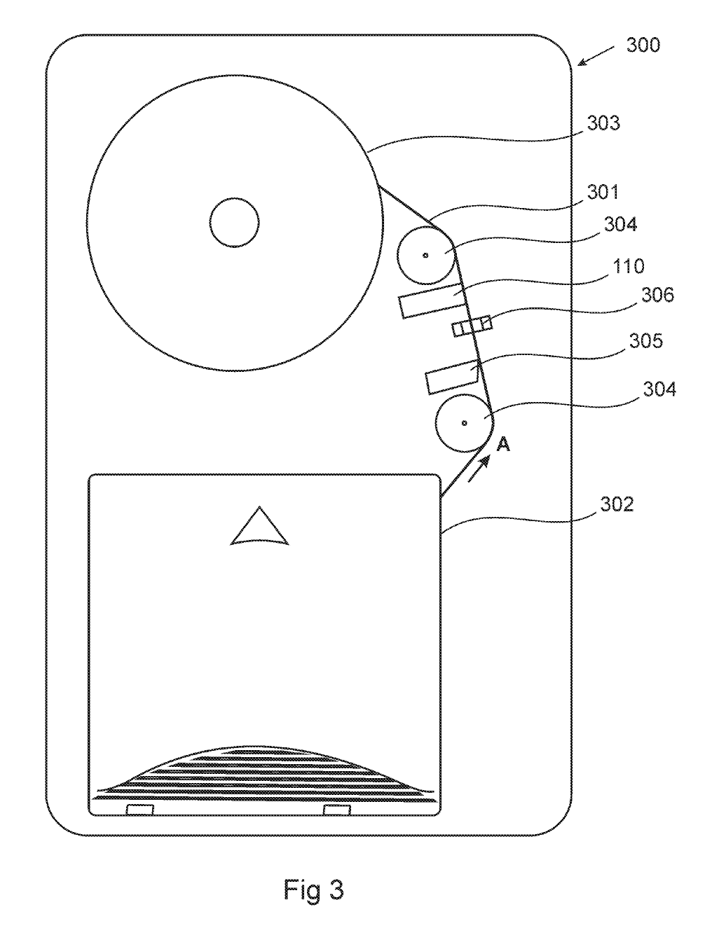

In FIG. 3 a tape deck 300 is shown. Tape 301 is moved from cartridge 302 to take-up reel 303 in direction of arrow A. The tape is guided by roller guides 304. When tape is moved over erase head 110 the data are erased from tape.

### Cleaning the Tape

Before tape reaches the erase head 110 it is moved over tape cleaner 305. Tape can carry large amounts of debris. This debris can contaminate the read/write head in the tape drive, which prevents the data from being written correctly to tape or from being read correctly from tape. The debris can also be deposited onto various tape path elements in the tape drive that are in contact with the tape. The moving tape may eventually dislodge the debris collected on a tape path element and thus, the debris collected from an extended length of tape is deposited back onto a small region on the tape. This creates an area of extensive contamination in that region, which can make the tape unusable. New tape may contain some debris that is generated by the manufacturing process known as slitting. However this debris is generally minor and is not cause for concern. Used tape, on the other hand, may contain a significant amount of debris. With continued use the wear of the tape can increase. Tape wear generates debris that can be deposited onto various tape path elements in the tape drive that are in contact with the tape. These deposits in the drive can accelerate the wear of the tape. It is not uncommon for used tapes to have large amounts of debris. Removing the debris during the refurbishing process is therefore highly desirable.

### Measuring the Tape Edge

Tape is also moved past optical edge sensor 306. As described above, the quality of the tape reference edge is important for the alignment between the read/write head and the tape. The reference edge of the tape is pushed against guiding elements in the tape path of a tape drive. Tapes with a straight reference edge are moved through the tape path with little or no lateral movement. A reference edge that follows a gentle wave may cause large lateral tape movements, but the head actuator is capable of following lateral tape movements that are slow, thereby maintaining the alignment between the head and the tape.

Severely damaged tape edges, however, can cause rapid and erratic lateral tape movements. The head actuator may not be able to follow these movements and the alignment between the head and the tape can no longer be maintained. These errors are commonly called “servo errors”. When such a servo error occurs while writing data to tape, the tape drive will disrupt the write process immediately and attempt to write the data further down on the tape. This is time consuming and reduces the usable capacity of the tape. A multitude of servo errors can cause the drive to abandon the write process entirely. A tape that causes a multitude of servo errors is therefore unusable.

Less severely damaged tape edges may not cause servo errors, but even minor edge damage can be of concern. Any damage to the tape reference edge can cause disturbances between the tape and the drive's tape path. These disturbances can increase the tape edge wear, causing further damage to the tape's reference edge. Damage of the tape edges is an indication that the tape's quality has deteriorated, even if the damage is presently still too small to cause servo errors.

### Statistical Data Stored in a Memory Chip

Several types of data cartridges contain a memory chip (MC) or similar device that stores statistical data of the cartridge. One such type of tape cartridge is that which adheres to the Linear Tape Open (LTO) format. Although repeated reference to the LTO format, in the following, is made it is understood that the present invention applies to all cartridges containing memory that store statistical data. This memory may be in the form of a separate memory chip (MC), or it may be in another suitable form.

The data stored in the MC may include the date of the manufacture of the cartridge, the number of times the cartridge was loaded, the number of data bytes written to the cartridge, the number of data bytes read from the cartridge, the number and types of errors previously encountered, as well as other parameters.

These data can be used to determine the quality of the tape cartridge. Determining the quality of a cartridge by evaluating a plurality of parameters can be inconsistent and subjective when done by humans. It is desirable to evaluate all cartridges consistently and objectively. In the preferred embodiment this is accomplished by automatically calculating a score value based on all relevant parameters. This score value may be a single number, ranging for example from 0 (bad) to 100 (good), a color spectrum ranging for example from red (bad) to green (good), a selection of words ranging for example from “bad” to “good”, or any other suitable expression of the overall cartridge quality.

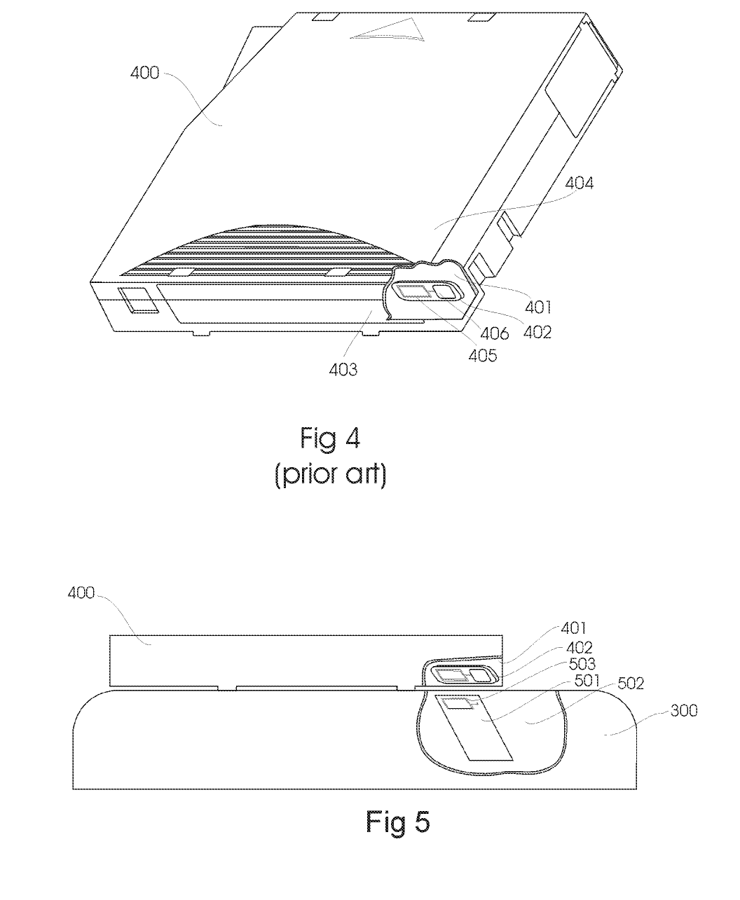

FIG. 4 shows a representative sample of a cartridge containing a MC. Section 401 has been removed from the cartridge 400 to show the location of internal MC 402. The MC is positioned at a 45-degree angle to allow access from the front 403 of the cartridge as well as from the top 404 or from the bottom of the cartridge. The actual location and orientation of the MC is media-dependent. The MC 402 comprises antenna 405 and storage element 406.

FIG. 5 shows a front view of tape deck 300, including cartridge 400. Section 401 has been removed from cartridge 400 to show the location of internal MC 402. Section 502 has been removed from tape deck 300 to show the location of interface module 501. Interface module 501 includes antenna 503 that is positioned in close proximity to the antenna of MC module 402. Interface module 501 also contains circuitry (not shown) to read the data stored in MC 402 and to write data to MC 402. The content of the MC depends on the type of cartridge used. The following example refers to those cartridges that adhere to the Linear Tape Open (LTO) format.

The content of the MC of LTO type cartridges is disclosed in ECMA319. The most important statistical data in the MC include the number and type of records with errors, the number of bytes read/written, the number of loads, and the age of the cartridge. Analysis of these parameters allows a score value to be calculated.

1. Percentage of Records with Errors

Error statistics can be one of the most important indicators of cartridge health. There are three types of errors: recovered data errors, unrecovered data errors, and servo errors. The percentage of records that had these errors, rather than the absolute number of errors recorded, is the figure used for this calculation.

2. Number of Bytes Read and Written

The number of bytes read and written refers to the total amount of data that has been transferred to and from the cartridge. This figure indicates the number of times the tape was moved through the drive's tape path.

3. Number of Cartridge Loads

If the number of times the cartridge has been loaded is disproportionately high relative to the number of bytes written or read, this indicates that only a few records were accessed each time the cartridge was loaded. Accessing random records on tape requires movement of the tape to locate the records. If this is the case, the actual amount of tape that moved through the drive's tape path is potentially much greater than the statistic of number of bytes transferred suggests. It should ideally require only one load to write at least one wrap (i.e., one movement of tape between beginning and end of tape in either direction). The number of loads should not exceed 50 times the number of bytes transferred, divided by the total cartridge capacity.

4. Age of Cartridge

A cartridge should last for a long time without any negative effects on its performance if it has been stored in a controlled environment. However, as a cartridge ages is it is natural that more opportunities would arise for its abuse. Since a newer cartridge is generally preferable to an old cartridge, statistically old age is considered a weak negative.

Score Algorithm

Looking at all the data to evaluate a cartridge can be time consuming, tedious, and inconsistent from one user to the next. It is therefore desirable to create a single score number that is automatically and consistently calculated from all available data. Three steps are taken in order to create this single score.

First, a curve is defined for each parameter, e.g., the number of bytes transferred to and from the cartridge. New cartridges carry debris generated by the slitting process during the manufacturing of the tape. Each data transfer signifies the movement of tape through the drive's tape path. During the first few passes, the tape pass cleans the slitting debris from the tape and the tape quality improves. With continued use the quality will slowly decline. Once a cartridge reaches its end of life, the quality rapidly decreases. FIG. 7 shows a curve for the above example.

The second step in calculating a score is to utilize each parameter as an index in the corresponding graph to determine a value called R which determines the impact of the parameter on the score. In the example of FIG. 7, the number of data transfers is used as an index on the horizontal axis. When the number of transfers is small, the R value is negative. As can be seen from the algorithm below, negative R values raise the score, while positive values lower the score. For example, at position p1 in FIG. 7 the R value is at its lowest, meaning that when the number of bytes transferred equals p1, the impact of this parameter on the score is positive. With additional data transfers the value of R increases slowly until the number of bytes transferred equals p2. At this point the cartridge is at the end of its life expectancy. Usage beyond that point will result in rapidly increased R values and thus a decreased score.

The step of determining the R value for a parameter by using the parameter value as an index to the corresponding graph is repeated for each parameter.

The third step is to assign a weight to each parameter. The final step is to add the weighted results for each parameter, and to assign it a score.

The score is therefore calculated according to the following algorithm:

$$Score = P - {\sum }_{n = 1}^{n = N} {W}_{n} * {R}_{n}$$

Where:
P is the highest possible score value. For example, if the score ranges from 0 to 100, P equals 100.
N is the total number of parameters
W is the weight of each parameter
R is the value obtained from the graph of each parameter

The process of accessing the MC in the cartridge, retrieving the relevant statistical data, and the method of calculating a single quality score based on the statistical data is described in more detail in U.S. patent application Ser. No. 11/935,223.

### Saving the Duality Information in the MC

The single value quality score based on the statistical data in the MC and the tape edge quality score are both very useful values for a potential buyer of the refurbished cartridge as well as for the reseller. For simplicity it is desirable to combine both values into a single quality value. This can be accomplished with the above-disclosed scoring algorithm. The combined single value quality score is useful in several ways.

A buyer may want to specify a minimum quality score of each of the cartridge he wishes to buy. Or he may want to specify a minimum average score value of the cartridges he wishes to buy. A seller may want to offer cartridges at different prices depending on their quality score. A buyer may take advantage of lower priced, lower quality cartridges for less demanding applications. For higher quality cartridges a buyer may be willing to pay a higher price.

As shown, disclosing the single value quality score when offering the cartridge for resale is very desirable. In the preferred embodiment the combined single value quality score is saved in the CM. A cartridge may travel from the seller to a reseller and then to an end user. Information about the cartridge can easily be lost if kept separately from the cartridge. The CM is an integral part of the cartridge and travels with the cartridge.

Additional information regarding the refurbishing process may also be added to the CM. Such information may include the date and time of the refurbishing, the name of the company that refurbished the cartridge, the serial number of equipment used for erasing the cartridge, and similar. This additional information can be useful in many instances for diagnosing problems and establishing cartridge history.

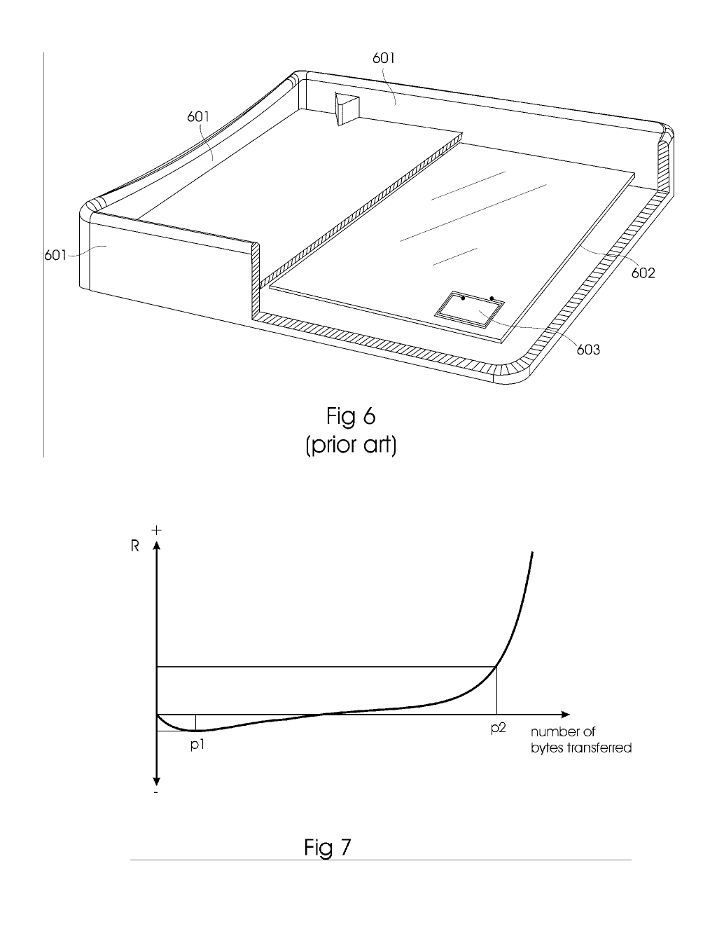

Once stored in the cartridge, the refurbishing data value can easily be extracted and displayed. A commercially available product from MPTapes, Inc. in Longmont, Colo. called VeriTape® is an example of a device capable of reading data from the CM and displaying the data on a computer screen. This device is shown in FIG. 6. The device 600 is open to the top to accept cartridge 400. It comprises four rounded walls 601. The walls are spaced in such a manner that there is a small clearance between the walls and the cartridge. This clearance allows the cartridge to be inserted and removed easily. A section has been removed from device 600 to show circuit board 602. On the top side of the board the antenna 603 is positioned to be in close proximity to the CM 405 (FIG. 4). The antenna is connected to the bottom side of the boards. Electrical components located on the bottom side of the board (not shown) are capable of accessing the CM 405 in cartridge 400 and extracting the data. A USB port (not shown) allows the device to be connected to a computer on which the single quality score value can be displayed.

1. The method of computing a single value quality score for a data cartridge and of disclosing the quality score when offering the data cartridge for resale.

2. The method of claim 1 further comprising adjusting the price of the cartridge offered for resale depending on the single value quality score, whereas the price of a cartridge with a lower quality score is lower than the price of a cartridge with a higher quality score.

3. The method of claim 1 where the computation of the single value quality score comprises using statistical data stored in a cartridge memory that are indicative of the cartridge quality wherein the single quality score is the sum of a plurality of weighted statistical data.

4. The method of claim 1 where the computation of the single value quality score further comprises using tape edge quality data.

5. The method of claim 1 where the single value quality score is stored in the cartridge memory.

6. The method of claim 5, where additional information regarding the refurbishing process is stored in the cartridge memory.
